(19) United States
(12) Patent Application Publication
(10) Pub. No.: US 2009/0085982 A1
(43) Pub. Date: Apr. 2, 2009

(54) Inkjet head and manufacturing method thereof

(75) Inventors: Young-Jae Kim, Suwon-si (KR); Jae-Woo Joung, Suwon-si (KR); Young-Seuck Yoo, Seoul (KR); Chang-Sung Park, Suwon-si (KR); Won-Chul Sim, Seongnam-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/010,203

(22) Filed: Jan. 22, 2008

(30) Foreign Application Priority Data
Sep. 27, 2007 (KR) 10-2007-0097202

(51) Int. Cl. B41J 2/045; B23P 17/00

(52) U.S. Cl. 347/68; 29/890.1

(57) ABSTRACT

An inkjet head and a manufacturing method thereof are disclosed. A method of manufacturing an inkjet head, which is configured to eject ink through a nozzle using pressure provided to a pressure chamber, that includes: processing a board to form the pressure chamber and the nozzle; stacking a protective cover on a lower surface of the board, where a recess is formed in the protective cover in a portion corresponding to a position of the nozzle; coupling a piezoelectric component onto an upper surface of the board; and perforating the protective cover by removing the portion where the recess is formed, can be used to efficiently prevent the contamination of the nozzles, to improve the manufacturing yield of the inkjet head.

### CROSS-REFERENCE TO RELATED APPLICATIONS

This application claims the benefit of Korean Patent Application No. 10-2007-0097202 filed with the Korean Intellectual Property Office on Sep. 27, 2007, the disclosure of which is incorporated herein by reference in its entirety.

### BACKGROUND

1. Technical Field

The present invention relates to an inkjet head and a manufacturing method thereof.

2. Description of the Related Art

Recent times have seen continued attempts to apply inkjet technology to various fields of art, such as in biochips, metal wiring in PCB's, and color patterns in LCD's, etc. In thus applying inkjet technology to new fields, situations may occur in which metal nanoparticles or high-viscosity polymers, etc., are ejected onto a board made of a special material, unlike the prior art of discharging low-viscosity ink drops onto paper to form letters or images.

Therefore, in order to apply inkjet technology to many fields, developments in the inkjet head are crucial. That is, an inkjet head is needed, which is able to eject ink droplets having high viscosities and provides high precision and high frequencies, and which is subject neither to chemical reactions in the head structure due to the ink particles nor to blockage in the nozzles. An inkjet printer head needs to be developed which can satisfy these various constraints.

Inkjet printing technology has been used mainly in the field of OA (office automation), as well as in industrial fields such as for package marking and printing on clothing. The applicability of inkjet printing technology, however, is gradually expanding, according to developments in functional ink, etc., such as that containing metal nanoparticles of silver and nickel, etc.

The process of forming the nozzles is a very important process in inkjet technology, as it is directly related to the success of ink ejection. In the procedures for manufacturing an inkjet head, the contamination of the nozzles can lead to various impurities entering the inkjet head, becoming a cause of improper ejection.

In prior art, the method of attaching tape onto the surface where the nozzles are formed is used in manufacturing the inkjet head, in order to protect the nozzles. However, in the procedure of removing the tape after the relevant process, the adhesive composition may not be completely removed, and the contamination of the nozzles is not efficiently prevented.

### SUMMARY

An aspect of the invention is to provide an inkjet head and a method of manufacturing the inkjet head, in which the contamination of the nozzles is prevented efficiently, and with which the manufacturing yield of the inkjet head is improved.

One aspect of the invention can provide an inkjet head that includes: a board, in which are formed a nozzle and a pressure chamber that supplies ink to the nozzle; a piezoelectric component, which is coupled to an upper surface of the board, and which is configured to provide pressure to the pressure chamber; and a protective layer, which is stacked onto a lower surface of the board, and in which an opening is formed in correspondence with a position of the nozzle.

A water-repellent layer may be formed on the lower surface of the board that is exposed through the opening.

The board can be made with silicon (Si) as the major constituent, while the protective layer can be made with glass as the major constituent.

Another aspect of the invention can provide a method of manufacturing an inkjet head, which is configured to eject ink through a nozzle using pressure provided to a pressure chamber. The method includes: processing a board to form the pressure chamber and the nozzle; stacking a protective cover on a lower surface of the board, where a recess is formed in the protective cover in a portion corresponding to a position of the nozzle; coupling a piezoelectric component onto an upper surface of the board; and perforating the protective cover by removing the portion where the recess is formed.

An additional operation may be performed of forming a water-repellent layer on a lower surface of the board exposed through a perforated part in the protective cover, while the area of the recess can correspond with an area of the water-repellent layer.

Also, the board can be made with silicon (Si) as the major constituent, while the protective layer can be made with glass as the major constituent.

Furthermore, the board may be made of multiple unit boards, and the method can include dicing the board into the unit boards, before perforating the protective cover.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a cross-sectional view illustrating an embodiment of an inkjet head according to an aspect of the invention.

FIG. 2 is a flowchart illustrating an embodiment of a method of manufacturing an inkjet head according to another aspect of the invention.

FIG. 3, FIG. 4, FIG. 5, FIG. 6, and FIG. 7 are cross-sectional views that represent a flow diagram for the method of manufacturing an inkjet head shown in FIG. 2.

### DETAILED DESCRIPTION

As the invention allows for various changes and numerous embodiments, particular embodiments will be illustrated in drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the invention.

The terms used in the present application are merely used to describe particular embodiments, and are not intended to limit the present invention. An expression used in the singular encompasses the expression of the plural, unless it has a clearly different meaning in the context. In the present application, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Embodiments of the inkjet head and manufacturing method thereof according to certain aspects of the invention will be described below in more detail with reference to the accompanying drawings, in which those components are rendered the same reference numeral that are the same or are in correspondence, regardless of the figure number, and redundant explanations are omitted.

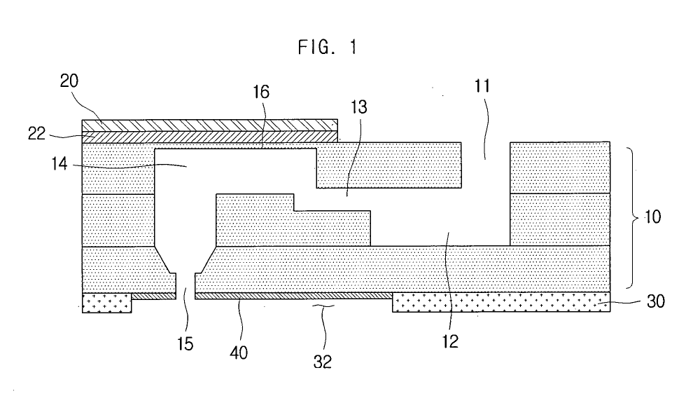

FIG. 1 is a cross-sectional view illustrating an embodiment of an inkjet head according to an aspect of the invention. In FIG. 1 are illustrated a board 10, an inlet 11, a reservoir 12, a restrictor 13, a pressure chamber 14, a nozzle 15, a vibrating plate 16, a piezoelectric component 20, an electrode 22, a protective layer 30, an opening 32, and a water-repellent layer 40.

The board 10 is the main body that forms the inkjet head according to this embodiment, and in the board 10 may be formed the inlet 11, reservoir 12, restrictor 13, pressure chamber 14, nozzle 15, and vibrating plate 16, etc. Such a board 10 can be formed by using a method of processing a single wafer, or a method of processing several sub-boards (not shown) and then stacking them together.

The board 10 may be made of a silicon material, or a stainless steel material, or any of a variety of other materials. This particular embodiment presents a board 10 made of a silicon material.

The reservoir 12 may contain ink supplied through the inlet 11, and may provide the ink to the pressure chamber 14 thorough the restrictor 13, which will be described below in further detail.

The restrictor 13 may serve as a channel that connects the pressure chamber 14 with the reservoir 12, and provide ink to the pressure chamber 14 from the reservoir 12. The restrictor 13 may be formed with a cross-sectional area smaller than that of the reservoir 12. Also, the restrictor 13 can control the amount of ink provided from the reservoir 12 to the pressure chamber 14 when the vibrating plate 16 is made to vibrate by the piezoelectric component 20.

The pressure chamber 14 may be connected with the reservoir 12 by the restrictor 13. Moreover, the side of the pressure chamber 14 which is not connected with the restrictor 13 may be connected with the nozzle 15. Therefore, the pressure chamber 14 may receive the ink from the reservoir 12 and provide the ink to the nozzle 15, whereby printing may take place.

The upper surface of the pressure chamber 14 may be covered by the vibrating plate 16, and the piezoelectric component 20 may be coupled to the upper surface of the vibrating plate 16 in correspondence to the location of the pressure chamber 14.

The piezoelectric component 20 may be positioned on the upper surface of the vibrating plate 16 in correspondence to the location of the pressure chamber 14, and may generate vibrations from the power supplied thereto. That is, the piezoelectric component 20 may supply pressure to the pressure chamber 14 via the vibrating plate 16 by generating a vibration according to the electrical power supplied. An electrode 22 can be formed between the piezoelectric component 20 and the vibrating plate 16.

The nozzle 15 may be connected with the pressure chamber 14, and may receive and jet the ink. When a vibration generated by the piezoelectric component 20 is provided to the pressure chamber 14, a pressure may be supplied to the pressure chamber 14, by which the nozzle 15 may jet the ink.

The protective layer 30 may be stacked onto the lower surface of the board 10 to prevent the nozzle 15 from becoming contaminated. That is, as illustrated in FIG. 1, the protective layer 30 may be shaped to have an opening 32, such that the portion where the nozzle 15 is formed is opened, while the remaining portion may be stacked on the board 10 to support the lower surface of the board 10.

Due to this structure, when an inkjet head according to this embodiment is placed in an external environment, such as on a work platform or jig, etc., the nozzle 15 can be spaced apart from the work platform or jig by the amount of thickness of the protective layer 30. Therefore, the nozzle 15 is prevented from direct contact with the work platform or jig, etc., and is thus prevented from contamination.

If the board 10 is made of a silicon (Si) material, a glass material can be used for the protective layer 30, in order that a secure coupling can be maintained between the board 10 and the protective layer 30. Of course, a protective layer of a silicon material may also be used, and if the board 10 is made of a stainless steel (SUS) material, a protective layer of a stainless steel material may be used.

On the lower surface of the board 10, a water-repellent layer 40 can be formed. Because of the water-repellent layer 40, the tension between the board 10 and the ink ejected through the nozzle 15 can be decreased, and as a result, the ink can be ejected in a stable manner.

While FIG. 1 presents a structure in which the water-repellent layer 40 is formed over the entire lower surface of the board 10 exposed through the opening 32, the water-repellent layer 40 may also be formed only on a portion around the nozzle 15.

The structure of an inkjet head according to an aspect of the invention has been described above, and now a method of manufacturing an inkjet head according to another aspect of the invention will be described below.

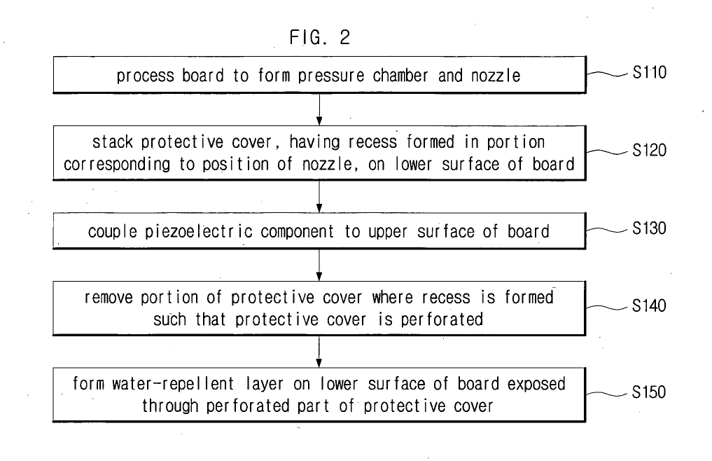

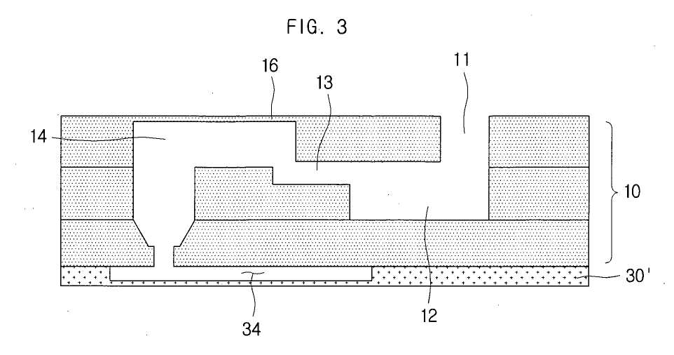

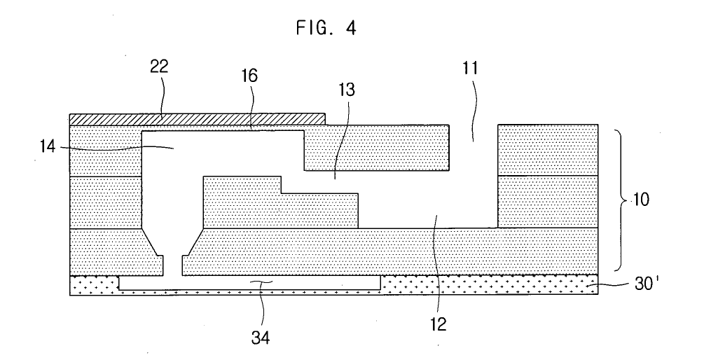

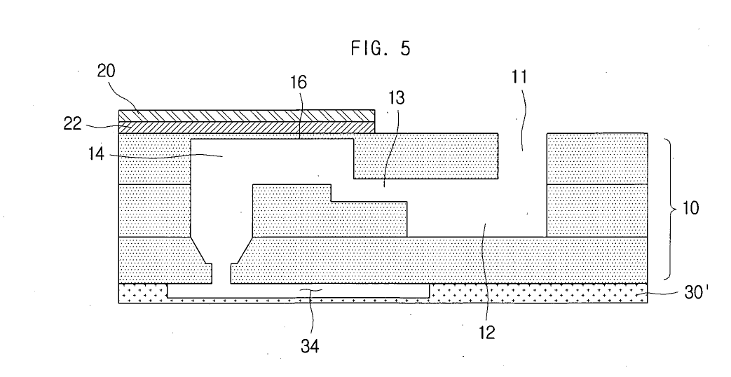

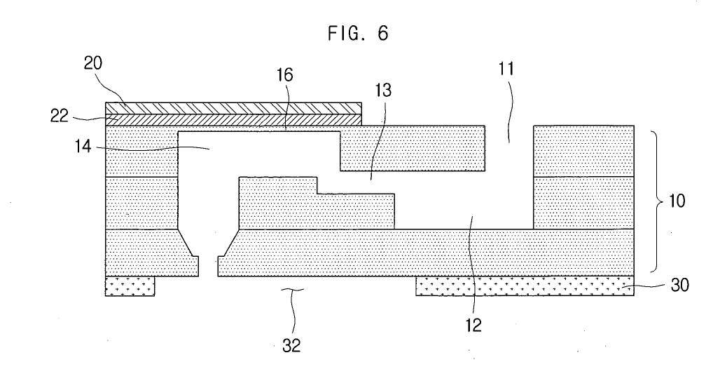

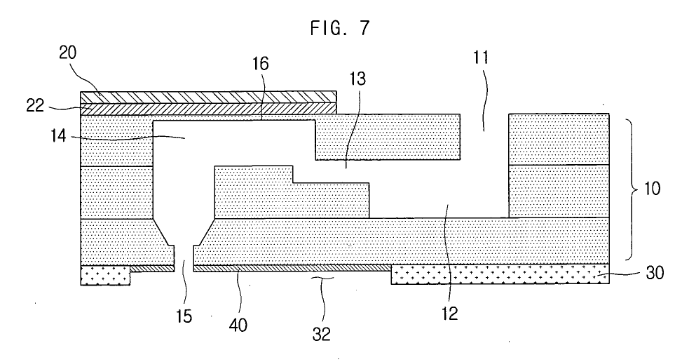

FIG. 2 is a flowchart illustrating an embodiment of a method of manufacturing an inkjet head according to another aspect of the invention, while FIG. 3 to FIG. 7 are cross-sectional views representing a flow diagram for the method of manufacturing an inkjet head shown in FIG. 2. In FIG. 3 to FIG. 7 are illustrated a board 10, an inlet 11, a reservoir 12, a restrictor 13, a pressure chamber 14, a nozzle 15, a vibrating plate 16, a piezoelectric component 20, an electrode 22, a protective layer 30, a protective cover 30′, an opening 32, a recess 34, and a water-repellent layer 40.

First, the board 10 may be processed to form the pressure chamber 14 and the nozzle 15 (S110). The board 10 is the main body that forms the inkjet according to this embodiment, and in addition to the pressure chamber 14 and nozzle 15, the inlet 11, reservoir 12, restrictor 13, and vibrating plate 16, etc. may be formed in the board 10.

The board 10 may be formed by using a method of processing a single wafer, or a method of processing several sub-boards (not shown) and then stacking them together.

The board 10 may be made of a silicon material, or a stainless steel material, or any of a variety of other materials. This particular embodiment presents a board 10 made of a silicon material.

Next, as illustrated in FIG. 3, a protective cover 30′, having a concave recess 34 formed in a portion corresponding to the position of the nozzle 15, may be stacked on the lower surface of the board 10 (S120). By using this protective cover 30′ to cover the lower surface of board 10 where the nozzle 15 is formed, the nozzle 15 is prevented from being exposed to the exterior and thus from a risk of contamination, during the processes for manufacturing the inkjet head.

If the board 10 is made of a silicon (Si) material, a protective cover 30′ made of a glass material can be used, in order that a secure coupling can be maintained between the board 10 and the protective cover 30′. Of course, a protective cover of a silicon material may also be used, and if the board 10 is made of a stainless steel (SUS) material, a protective cover of a stainless steel material may be used.

Next, a piezoelectric component 20 may be coupled to the upper surface of the board 10 (S130). The piezoelectric component 20 may be positioned on the upper surface of the vibrating plate 16 in correspondence to the location of the pressure chamber 14, and may generate vibrations from the power supplied the piezoelectric component 20. That is, the piezoelectric component 20 may supply pressure to the pressure chamber 14 via the vibrating plate 16 by generating a vibration according to the electrical power supplied.

For this, an electrode 22 can be formed on the upper surface of the board 10, as illustrated in FIG. 4, after which the piezoelectric component 20 can be coupled onto the electrode 22, as illustrated in FIG. 5. During the procedures of forming the electrode 22 on the upper surface of the board 10 and coupling the piezoelectric component 20 on the electrode 22, the protective cover 30′ may prevent the nozzle 15 from becoming contaminated.

If the board 10 is composed of a plurality of unit boards, that is, if the inkjet head is manufactured in a wafer scale, a method may be used of forming the electrode 22, dicing the board 10 into each unit board, and then coupling the piezoelectric component 20 to each unit board. Even when the board 10 is diced thus, the nozzle can be protected by the protective cover 30′.

Next, as illustrated in FIG. 6, the portion of the protective cover 30′ in which the recess 34 is formed may be removed such that the protective cover 30′ is perforated (S140). Removing the portion where the recess 34 is formed may be achieved by employing a method of applying an impact to shatter the relevant portion, or of exposing the lower surface of the protective cover 30′ to an etchant. Of course, any of various other methods can be used. By thus removing the portion of the protective cover 30′ where the recess 34 is formed, the same structure as the protective layer 30 illustrated in FIG. 1 can be obtained.

Next, as illustrated in FIG. 7, a water-repellent layer 40 may be formed on the lower surface of the board 10 exposed through the perforated part of the protective cover 30′ (S150). Because of the water-repellent layer 40, the tension between the board 10 and the ink ejected through the nozzle 15 can be decreased, and as a result, the ink can be ejected in a stable manner.

In order to more efficiently control the position where the water-repellent layer 40 may be formed, the area of the recess 34 formed in the protective cover 30′ can be designed to correspond with the desired area of the water-repellent layer 40. In other words, the area of the recess 34 and the area of the water-repellent layer 40 can be substantially the same. In this way, after removing the portion where the recess 34 is formed, the portions that are not removed may serve as a resist in forming the water-repellent layer 40, so that the water-repellent layer 40 may be formed with greater ease.

As in certain aspects of the invention set forth above, by stacking a protective cover on the lower surface of the board where the nozzle is formed, in the initial stages of manufacturing an inkjet head, the contamination of the nozzles can be prevented efficiently, and the manufacturing yield of the inkjet head can be improved.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

Many embodiments are encompassed by the claims of the present invention, besides those set forth above.

What is claimed is:

1. An inkjet head comprising:
a board having a nozzle and a pressure chamber formed therein, the pressure chamber configured to supply ink to the nozzle;
a piezoelectric component coupled to an upper surface of the board and configured to provide pressure to the pressure chamber; and
a protective layer stacked on a lower surface of the board and having an opening formed therein in correspondence with a position of the nozzle.

2. The inkjet head of claim 1, wherein a water-repellent layer is formed on a lower surface of the board exposed through the opening.

3. The inkjet head of claim 1, wherein the board comprises silicon (Si),
and the protective layer comprises glass.

4. A method of manufacturing an inkjet head, the inkjet head configured to eject ink through a nozzle using pressure provided to a pressure chamber, the method comprising:
processing a board to form the pressure chamber and the nozzle;
stacking a protective cover on a lower surface of the board, the protective cover having a recess formed therein in a portion corresponding to a position of the nozzle;
coupling a piezoelectric component onto an upper surface of the board; and
perforating the protective cover by removing the portion where the recess is formed.

5. The method of claim 4, further comprising:
forming a water-repellent layer on a lower surface of the board exposed through a perforated part in the protective cover.

6. The method of claim 4, wherein the board comprises silicon (Si),
and the protective cover comprises glass.

7. The method of claim 4, wherein an area of the recess is in correspondence with an area of the water-repellent layer.

8. The method of claim 4, wherein the board comprises a plurality of unit boards,
and the method further comprises, before perforating the protective cover:
dicing the board into the unit boards.
